(19) United States
(12) Patent Application Publication
(10) Pub. No.: US 2024/0249165 A1
(43) Pub. Date: Jul. 25, 2024

(54) SYSTEM AND METHOD FOR MANAGEMENT OF DISTRIBUTED INFERENCE MODEL GENERATION

(71) Applicant: Dell Products L.P., Round Rock, TX (US)

(72) Inventors: IAN ROCHE, Glanmire (IE); PHILIP E. HUMMEL, San Jose, CA (US); DHARMESH M. PATEL, Round Rock, TX (US)

(21) Appl. No.: 18/159,246

(22) Filed: Jan. 25, 2023

(51) Int. Cl. G06N 5/04

(52) U.S. Cl. CPC G06N 5/04

(57) ABSTRACT

Methods and systems for providing computer implemented services using inference models are disclosed. The inference models may be obtained through federated learning, and may be used to generate output used in the computer implemented services. During the federated learning, instances of inference models may be generated using siloed data with distribution restrictions. Some of the instances of the inference models may be selected for continued learning to obtain a final inference model used to generate the output.

### FIELD

Embodiments disclosed herein relate generally to model generation. More particularly, embodiments disclosed herein relate to systems and methods to manage generation of models while respecting data access restrictions.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show a diagram illustrating data flows in accordance with an embodiment.

FIG. 3 show flow a diagram illustrating a method of providing computer implemented services using a final inference model in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer implemented services. To provide the computer implemented services, data may be stored and used in the services.

Various patterns may be present in the data, and inference models may be used to identify and/or otherwise use the presence of the patterns to provide the computer implemented services. To identify presence of the patterns, inference models may be used. The inference models may ingest the data and provide output. The inference models may used generalized relationships which define the output in terms of the ingested data.

The generalized relationships may be established through training processes where data reflecting the relationships is used to obtain the inference models. However, some of the data reflecting the relationships may include access restrictions. For example, various portions of the data may be siloed thereby preventing aggregation of all of the data in a single location.

To obtain an inference model reflecting the relationships while respecting the access restrictions, a federated learning process may be performed. During the federated learning, inference models may be trained only using respective portions of the data. Once trained, some of the inference models may be selected for continued learning. The models may be selected based on their likelihood to improve the accuracy and/or other capabilities of a final inference model.

By doing so, the computational cost for obtaining a final inference model may be reduced when compared to using all of the inference models for continued learning.

Thus, embodiments disclosed herein may address, among other problems, the technical problem of limited availability of computing resources in distributed systems. Embodiments disclosed herein may address this technical problem by reducing resource consumption for federated learning.

In an embodiment, a method for providing computer implemented services using a final inference model is provided. The method may include obtaining inference models using local data sources, the inference models being obtain by data processing systems that have access to respective portions of the local data sources, and each of the data processing systems not having access to more than one of the respective portions of the local data sources; obtaining, based on the local data sources, synthetic data that is representative of features of the local data sources but cannot be used to obtain the local data sources; classifying, using the synthetic data, the inference models into a first group and a second group; performing, using the first group of the inference models, federated learning across a portion of the data processing systems that host the first group of the inference models to obtain the final inference model; and using the final inference model to provide the computer implemented services.

The final inference model may not be based on the second group of the inference models.

Obtaining the inference models using the local data sources may include, by a data processing system of the data processing systems: obtaining training data using a respective portion of the local data sources; and training, using the training data, an inference model of the inference models.

Classifying, using the synthetic data, the inference models into the first group and the second group may include, by the data processing system of the data processing systems: ingesting, by the inference model, a feature of a record of the synthetic data to obtain an output; making a comparison between the output to an average output to identify a level of difference, the average output being based on outputs generated by the inference models from ingestion of the feature of the record; and placing the data processing system in the first group or the second group based on the level of the difference.

Placing the data processing system in the first group or the second group based on the level of the difference may include making a determination regarding whether the level of difference exceeds a difference threshold; in a first instance of the determination where the level of difference exceeds the threshold: placing the data processing system in the first group; and in a second instance of the determination where the level of difference is within the threshold: placing the data processing system in the second group.

Performing the federated learning may include exchanging learning data with the portion of the data processing systems; and obtaining the final inference model using the learning data.

Using the final inference model to provide the computer implemented services may include distributing the final inference model to the data processing systems; and generating, using copies of the final inference model that are local to the data processing systems, inference using new data from the respective portions of the local data sources.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

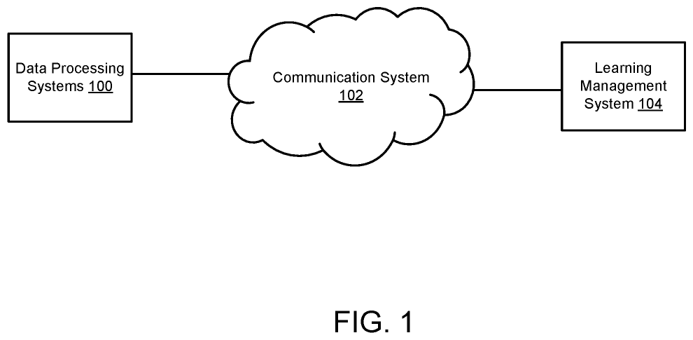

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer-implemented services, the system may include any number of data processing systems 100. Data processing systems 100 may provide the computer implemented services to users of data processing systems 100 and/or to other devices (not shown), and/or may cooperate with other devices that provide the computer implemented services. Different data processing systems may provide similar and/or different computer implemented services.

To provide the computer-implemented services, each of data processing systems 100 may obtain, access, process, and/or otherwise utilize data. The data may include any type and quantity of information.

Different data processing systems may only have access to various portions of the aggregate data accessible by all of data processing systems 100. For example, various portions of the aggregate data may be siloed or otherwise restricted from being distributed among the data processing systems. Consequently, each of the data processing systems may only have access to a limited quantity of the aggregate data.

In general, embodiments disclosed herein may provide methods, systems, and/or devices for providing computer implemented services using data processing systems 100. To provide the computer implemented services, data processing systems 100 may utilize inference models.

The inference models may be implemented suing any number and types of learning models such as, for example, machine learning models, decisions tree models, various classifiers such as support vector machines, and/or any other type of learning model. The quality (e.g., accuracy) of the inferences provided by the inference models may be based on the quantity, diversity, and types of data available to train the learning models.

Because some of the aggregate data available to data processing systems 100 is restricted from distribution, access to all of the aggregate data may not be possible. To facilitate model training, the system of FIG. 1 may implement federated learning. During federated learning, multiple inference models based on different portions of aggregate data may be generated so that siloed data may not need to be distributed (e.g., to establish a single location where all of the aggregate data is available for use). A final inference model may then be generated using the multiple inference models without distributing copies of the information upon which the multiple inference models are based. Consequently, restrictions on the distribution of various portions of data may be respected while obtaining a final inference model that may generalize relationships from the aggregate data.

To manage federated learning, the system of FIG. 1 may include learning management system 104. While illustrated as being separate from data processing systems 100 in FIG. 1, the data processing systems may perform the functionality of learning management system 104 without departing from embodiments disclosed herein. For example, learning management system 104 may be implemented using devices that are separate from data processing systems 100, or using a service which may be hosted by all, or a portion, of data processing systems 100.

To manage federated learning, learning management system 104 may (i) select types of models to train, (ii) initiate training of instances of the selected types of models by the data processing systems (which may do so with different portions of aggregate data that are siloed against distribution), (iii) classify the trained instances into different groups, and (iv) only use trained instances that are members of a portion of the different groups to perform federated learning. By doing so, the computing resource cost for performing federated learning may be reduced (e.g., by reducing the quantity of exchanged information and/or training cycles).

To classify the trained instances of a model, learning management system 104 may evaluate whether inclusion of each trained instance in federated learning is likely to produce a final inference model that has a high predictive power level across a wider range of input data. To evaluate the trained instances, synthetic data that reflects features in aggregate data but that does not allow for the aggregate data to be identified may be used. The trained instances may ingest the synthetic data and generate output. The output of the inference models for each record in the synthetic data may be used to (i) identify an average output (e.g., the common output) and (ii) differences between the output generated by each inference model and the average output. The differences may be used as a basis for selecting into which group to place the inference models.

For example, trained instances that generate output that diverges away from the average output may be added to a first group while other trained instances that generate output that aligns with the average output may be added to a second group.

Once the groups are identified, only members of some of the groups may be selected and used for federated learning. Following the previous example, the first group may be selected based on the high degree of divergence of the output of the members of the first group with respect to the average output of the trained instances. The second group may be discarded or otherwise not utilized for federated learning.

By doing so, the computational cost of federated learning may be reduced while respecting limitations on distribution of data.

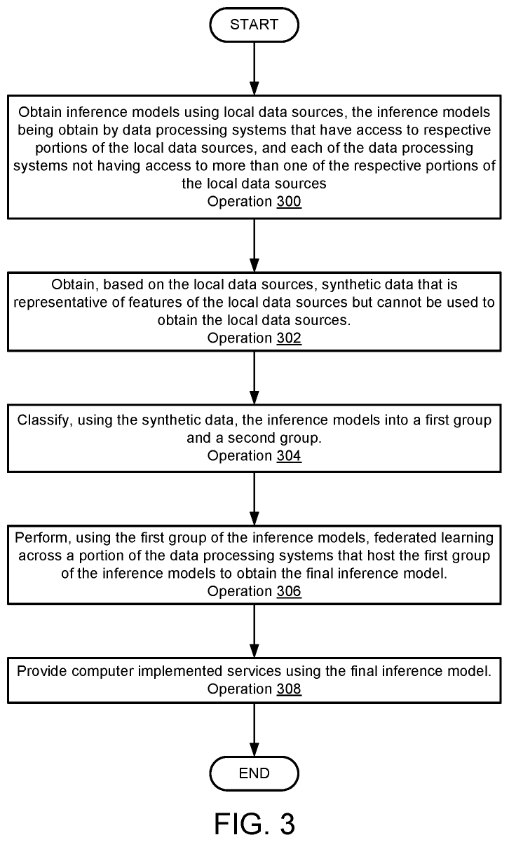

When providing their functionality, any of data processing system 100 and learning management system 104 may perform all, or a portion, of the method illustrated in FIG. 3.

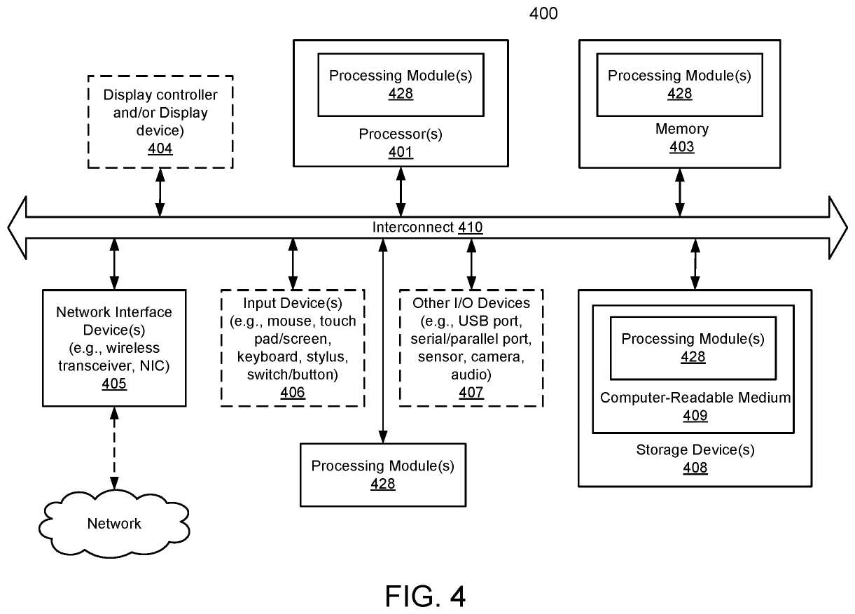

Any of data processing systems 100 and/or learning management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

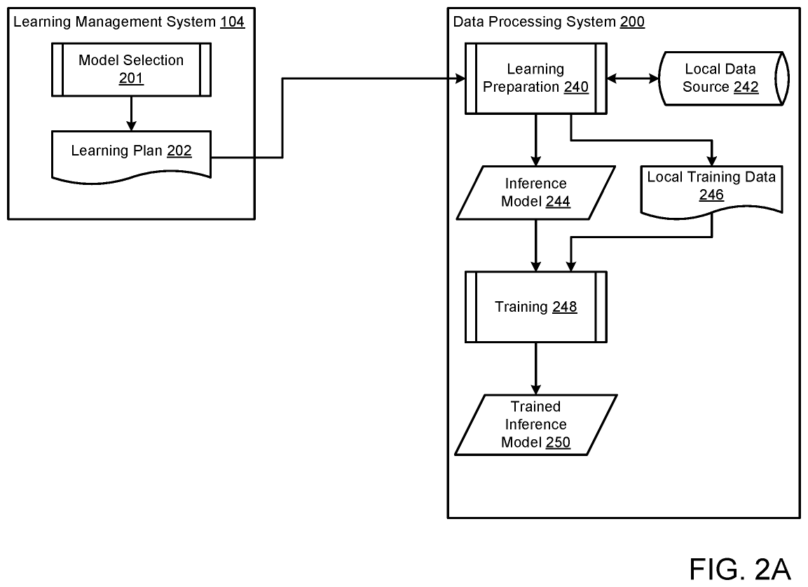

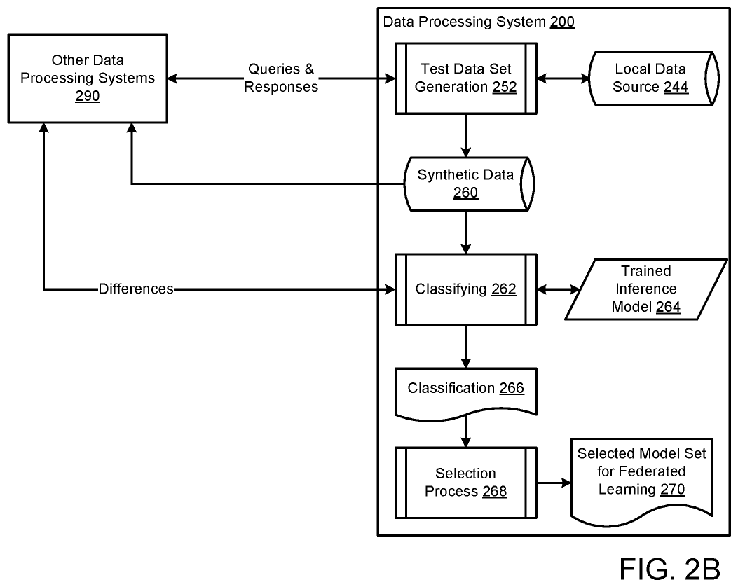

To further clarify embodiments disclosed herein, diagrams illustrating data flows implemented by and data structures used by a system over time in accordance with an embodiment are shown in FIGS. 2A-2B. In FIGS. 2A-2B, data structures are represented using a first set of shapes (e.g., 202, 242), models are represented using a second set of shapes (e.g., 244), and processes are represented using a third set of shapes (e.g., 200).

Turning to FIG. 2A, a first data flow diagram illustrating data flows, data processing, and/or other operations that may be performed by the system of FIG. 1 in accordance with an embodiment is shown.

To initiating generation of a final inference model, learning management system 104 may perform model selection 201. During model selection 201, various information regarding a desired goal for the final inference model may be used to select a type of inference model to be used for the final inference model. For example, the goals for the final inference model may be used to perform a lookup for (e.g., in a lookup data structure) or otherwise identify a type for the final inference model.

Learning plan 202 may be generated based on the type of the inference model. For example, learning plan 202 may specify the features (e.g., input) that are to be ingested by the final inference model and the type of output to be generated by the final inference model. Learning plan 202 may also specify the type of model to be generated, and/or information regarding the process through which the inference model is to be obtained. The information may reflect, for example, numbers and/or other criteria for determining which inference models will be used as a basis for federated learning.

Once obtained, learning plan 202 may be distributed to any number of data processing systems (e.g., 200) that may have access to local data sources (e.g., 242) that may not be distributed. Learning preparation 240 may be performed based on learning plan 202. During learning preparation 240, data processing system 200 may prepare inference model 244 (e.g., of a type specified by learning plan 202) for training and obtain local training data 246 (based on the ingest/output specified by learning plan 202) to perform the training. Local training data 246 may be obtained from local data source 242. Local data source 242 may be a data source that includes data accessible by data processing system 200 but that may not be distributed to other data processing systems (and/or other devices).

Training 248 may be performed using inference model 244 and local training data 246. During training 248, various parameters of inference model 244 may be set such that trained inference model 250 generalizes one or more relationships in local training data 246. Training 248 may be performed based on the type of inference model 244.

For example, if inference model 244 is a machine learning model, then training 248 may set weight for neurons of inference model 244 using an optimization process driven by local training data 246.

Once obtained, trained inference model 250 may be able to generate inferences that are of the types of output specified by learning plan 202 when ingest specified by learning plan 202 is ingested by trained inference model 250. However, by virtue of only being trained using local training data 246, trained inference model 250 may not accurately generalize relationships present in additional training data that may be siloed in other data processing systems.

To address this limitation, a federated learning process may be performed where multiple data processing systems that have obtained trained inference models, using only local data sources, may be used to obtain a final inference model that generalizes the relationships present in local data sources from each of the data processing systems. During federated learning, information regarding the models themselves rather than the training data used to obtain the inference models may be exchanged. The exchanged information may be used to establish the final inference model. Consequently, exchanging this type of data, rather than local training data, may facilitate final inference model generation while respecting restrictions on distribution of data. In other words, through federated learning, the training data used to train the respective inference models may not need to be aggregated together to obtain the final inference model.

However, performing federated learning with all inference models may not necessarily provide a final inference model that is of better quality (e.g., able to generate inferences that are more accurate or across wider input ranges). To reduce computing resource use for federated learning, the system may select a subset of the inference models with which to perform federated learning.

Turning to FIG. 2B, a second data flow diagram illustrating data flows, data processing, and/or other operations that may be performed by the system of FIG. 1 in accordance with an embodiment is shown.

To identify a selected model set for federated learning (e.g., 270), test data set generation 252 may be performed. During test data set generation 252, synthetic data 260 may be generated. Synthetic data 260 may include features representative of the features of local data sources 242 and/or local data sources of other data processing systems 290.

For example, various queries may be distributed to any number of data processing systems that may host inference models which may be used to perform federated learning. Responses to those queries may include portions of synthetic data 260. Consequently, synthetic data 260 may be obtained in a single location, but may not be used to obtain any of the sensitive data stored in any of the data processing systems. Copies of synthetic data 260 may be distributed to the other data processing systems.

Once obtained, synthetic data 260 may be used during classifying 262 to classify any number of trained inference models (e.g., 264) which may be used to perform federated learning. During classifying 262, features of each record of synthetic data 260 may be ingested by the respective trained inference models to establish an average output based on the ingested features. A difference between an output generated by an inference model and the average output may be obtained. This process may be repeated for all of the records of synthetic data 260 to identify an average difference for each inference model.

The trained inference models may then be classified into two or more groups based on the average differences. For example, all inference models associated with an average difference that exceeds a threshold may be added to a first group and the remaining inference models may be classified into a second group.

The threshold may be set, for example, (i) based on a target number of inference models, with the threshold being adjusted until the first group includes members of the target number, (ii) based on computational resource expenditure limitations for the federated learning, and/or (iii) based on other considerations.

Once classified, classifications 266 may be used in selection process 268 to obtain selected final model set for federated learning 270. During selection process 268, the inference models having a particular classification (e.g., members of one of the groups) may be selected as the selected model set for federated learning. For example, the inference models classified into the first group (e.g., the inference models that are associated with large differences between their outputs and the average output) may be used as the selected model set for federated learning.

Once selected model set for federated learning 270 is obtained, federated learning may be performed. The federated learning process may be performed by (i) exchanging information based on the respective inference models, (ii) performing various training cycles for the inference models using only the local data sources for the respective inference models, and/or (iii) performing other actions to obtain a final inference model that generalizes relationships present in data across the data processing systems without distributing the siloed portions of the data thereby respecting distribution limitations.

In an embodiment, any of data processing systems 200, 290 are implemented using a hardware device including circuitry. The hardware device may be, for example, a digital signal processor, a field programmable gate array, or an application specific integrated circuit. The circuitry may be adapted to cause the hardware device to perform the functionality of data processing systems 200, 290 as discussed herein. Learning system 104 may be implemented using other types of hardware devices without departing embodiment disclosed herein.

In an embodiment, any of data processing systems 200, 290 are implemented using a processor adapted to execute computing code stored on a persistent storage that when executed by the processor performs the functionality of data processing systems 200, 290 discussed throughout this application. The processor may be a hardware processor including circuitry such as, for example, a central processing unit, a processing core, or a microcontroller. The processor may be other types of hardware devices for processing information without departing embodiment disclosed herein.

In an embodiment, any of data processing systems 200, 290 include storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store any of the data structures discussed herein. Any of these data structures may be implemented using, for example, lists, tables databases, linked lists, unstructured data, and/or other types of data structures.

As discussed above, the components of FIG. 1 may perform various methods to manage operation of data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the operation of data processing systems in accordance with an embodiment is shown. The method may be performed by any of data processing systems 100, learning management system 104, or other components of the system shown in FIG. 1.

At operation 300, inference models are obtained using local data sources. The inference models may be obtained by training instances of an inference model using different portions of data. The data may be siloed and/or otherwise restricted from distribution. Each of the instances may be trained using data processing systems that (i) are only able to access a corresponding portion of the data, and (ii) may not be able to access other portions of the data.

At operation 302, synthetic data that is representative of features of the local data sources used to obtain the inference model but that cannot be used to obtain the local data sources is obtained. The synthetic data may be obtained by averaging or otherwise analyzing the local data to generate the synthetic data. The synthetic data may include any number of records.

At operation 304, the inference models are classified into a first group and second group. The inference models may be classified by (i) ingesting the records by the respective inference models to obtain corresponding outputs, (ii) averaging the outputs corresponding to each record, (iii) for each inference model, calculating a difference between its output and the average output for each record to obtain an average difference, (iv) adding inference models having an associated average difference that exceeds a threshold to the first group (e.g., a first classification indicating that the members of the classification likely include information likely to expand accuracy and/or capabilities of a final inference model), and/or (v) adding inference models having an associated average difference that does not exceed the threshold to the second group (e.g., a second classification indicating that the members of the classification likely do not include information likely to expand accuracy and/or capabilities of a final inference model).

At operation 306, federated learning is performed across a portion of the data processing systems that host the first group of the inference models to obtain the final inference model. During the federated learning, a new inference model that generalizes relationships reflected in the inference models that are members of the first group.

At operation 308, computer implemented services are provided using the final inference model. The computer implemented services may be provided by (i) ingesting data into an instance of the final inference model to obtain output, and (ii) using the output to provide the computer implemented services.

The instance of the inference model may be obtained, for example, by distributing the final inference model to any number of data processing systems. Consequently, multiple data processing systems may utilize the final inference model.

The method may end following operation 308.

Using the method illustrated in FIG. 3, embodiments disclosed herein may facilitate performance of computer implemented services using inference models obtained with federated learning that may consume reduced levels of computing resources. To do so, only a portion of inference models eligible for federated learning may be used to perform the federated learning. The portion of the inference models may be selected based on the propensity of each inference model to improve the accuracy and/or capabilities of a resulting final inference model.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows operating system from Microsoft®, Mac OS®/iOS® from Apple, Android® from Google®, Linux, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing computer implemented services using a final inference model, the method comprising:
obtaining inference models using local data sources, the inference models being obtain by data processing systems that have access to respective portions of the local data sources, and each of the data processing systems not having access to more than one of the respective portions of the local data sources;
obtaining, based on the local data sources, synthetic data that is representative of features of the local data sources but cannot be used to obtain the local data sources;
classifying, using the synthetic data, the inference models into a first group and a second group;
performing, using the first group of the inference models, federated learning across a portion of the data processing systems that host the first group of the inference models to obtain the final inference model; and
using the final inference model to provide the computer implemented services.

2. The method of claim 1, wherein the final inference model is not based on the second group of the inference models.

3. The method of claim 2, wherein obtaining the inference models using the local data sources comprises:
by a data processing system of the data processing systems:
obtaining training data using a respective portion of the local data sources; and
training, using the training data, an inference model of the inference models.

4. The method of claim 3, wherein classifying, using the synthetic data, the inference models into the first group and the second group comprises:
by the data processing system of the data processing systems:
ingesting, by the inference model, a feature of a record of the synthetic data to obtain an output;
making a comparison between the output to an average output to identify a level of difference, the average output being based on outputs generated by the inference models from ingestion of the feature of the record; and
placing the data processing system in the first group or the second group based on the level of the difference.

5. The method of claim 4, wherein placing the data processing system in the first group or the second group based on the level of the difference comprises:
making a determination regarding whether the level of difference exceeds a difference threshold;
in a first instance of the determination where the level of difference exceeds the threshold;
placing the data processing system in the first group; and
in a second instance of the determination where the level of difference is within the threshold:
placing the data processing system in the second group.

6. The method of claim 5, wherein performing the federated learning comprises:
exchanging learning data with the portion of the data processing systems; and
obtaining the final inference model using the learning data.

7. The method of claim 6, wherein using the final inference model to provide the computer implemented services comprises:
distributing the final inference model to the data processing systems; and
generating, using copies of the final inference model that are local to the data processing systems, inference using new data from the respective portions of the local data sources.

8. A non-transitory machine-readable medium having instructions stored therein, which when executed by a processor, cause the processor to perform operations for providing computer implemented services using a final inference model, the operations comprising:
obtaining inference models using local data sources, the inference models being obtain by data processing systems that have access to respective portions of the local data sources, and each of the data processing systems not having access to more than one of the respective portions of the local data sources;
obtaining, based on the local data sources, synthetic data that is representative of features of the local data sources but cannot be used to obtain the local data sources;
classifying, using the synthetic data, the inference models into a first group and a second group;
performing, using the first group of the inference models, federated learning across a portion of the data processing systems that host the first group of the inference models to obtain the final inference model; and
using the final inference model to provide the computer implemented services.

9. The non-transitory machine-readable medium of claim 8, wherein the final inference model is not based on the second group of the inference models.

10. The non-transitory machine-readable medium of claim 9, wherein obtaining the inference models using the local data sources comprises:
by a data processing system of the data processing systems:
obtaining training data using a respective portion of the local data sources; and
training, using the training data, an inference model of the inference models.

11. The non-transitory machine-readable medium of claim 10, wherein classifying, using the synthetic data, the inference models into the first group and the second group comprises:
by the data processing system of the data processing systems:
ingesting, by the inference model, a feature of a record of the synthetic data to obtain an output;
making a comparison between the output to an average output to identify a level of difference, the average output being based on outputs generated by the inference models from ingestion of the feature of the record; and
placing the data processing system in the first group or the second group based on the level of the difference.

12. The non-transitory machine-readable medium of claim 11, wherein placing the data processing system in the first group or the second group based on the level of the difference comprises:
making a determination regarding whether the level of difference exceeds a difference threshold;
in a first instance of the determination where the level of difference exceeds the threshold:
placing the data processing system in the first group; and
in a second instance of the determination where the level of difference is within the threshold:
placing the data processing system in the second group.

13. The non-transitory machine-readable medium of claim 12, wherein performing the federated learning comprises:
exchanging learning data with the portion of the data processing systems; and
obtaining the final inference model using the learning data.

14. The non-transitory machine-readable medium of claim 13, wherein using the final inference model to provide the computer implemented services comprises:
distributing the final inference model to the data processing systems; and
generating, using copies of the final inference model that are local to the data processing systems, inference using new data from the respective portions of the local data sources.

15. A data processing system, comprising:
a processor; and
a memory coupled to the processor to store instructions, which when executed by the processor, cause the processor to perform operations for providing computer implemented services using a final inference model, the operations comprising:
obtaining inference models using local data sources, the inference models being obtain by data processing systems that have access to respective portions of the local data sources, and each of the data processing systems not having access to more than one of the respective portions of the local data sources;
obtaining, based on the local data sources, synthetic data that is representative of features of the local data sources but cannot be used to obtain the local data sources;
classifying, using the synthetic data, the inference models into a first group and a second group;
performing, using the first group of the inference models, federated learning across a portion of the data processing systems that host the first group of the inference models to obtain the final inference model; and
using the final inference model to provide the computer implemented services.

16. The data processing system of claim 15, wherein the final inference model is not based on the second group of the inference models.

17. The data processing system of claim 16, wherein obtaining the inference models using the local data sources comprises:
by a data processing system of the data processing systems:
obtaining training data using a respective portion of the local data sources; and
training, using the training data, an inference model of the inference models.

18. The data processing system of claim 17, wherein classifying, using the synthetic data, the inference models into the first group and the second group comprises:
by the data processing system of the data processing systems:
ingesting, by the inference model, a feature of a record of the synthetic data to obtain an output;
making a comparison between the output to an average output to identify a level of difference, the average output being based on outputs generated by the inference models from ingestion of the feature of the record; and
placing the data processing system in the first group or the second group based on the level of the difference.

19. The data processing system of claim 18, wherein placing the data processing system in the first group or the second group based on the level of the difference comprises:
making a determination regarding whether the level of difference exceeds a difference threshold;
in a first instance of the determination where the level of difference exceeds the threshold:
placing the data processing system in the first group; and
in a second instance of the determination where the level of difference is within the threshold:
placing the data processing system in the second group.

20. The data processing system of claim 19, wherein performing the federated learning comprises:
exchanging learning data with the portion of the data processing systems; and
obtaining the final inference model using the learning data.
